(19) United States
(12) Patent Application Publication
(10) Pub. No.: US 2026/0176456 A1
(43) Pub. Date: Jun. 25, 2026

(54) COMPOSITON FOR AUTOMOTIVE EXTERIOR PARTS

(71) Applicant: BOREALIS AG, Vienna (AT)

(72) Inventors: Claudia KNIESEL, Linz (AT); Angelica Maëlle Delphine LEGRAS, Linz (AT); Jingbo WANG, Linz (AT); Pauli LESKINEN, Porvoo (FI); Markus GAHLEITNER, Linz (AT); Klaus BERNREITNER, Linz (AT)

(73) Assignee: BOREALIS AG, Vienna (AT)

(21) Appl. No.: 19/126,078

(22) PCT Filed: Oct. 31, 2023
(86) PCT No.: PCT/EP2023/080325

§ 371 Date: Apr. 30, 2025

(30) Foreign Application Priority Data
Oct. 31, 2022 (EP) 22204692.2

(51) Int. Cl. C08L 23/16; C08F 2/00; C08F 4/646; C08F 210/06; C08L 23/06; C08L 23/0807; C08L 23/12; C08L 23/14

(52) U.S. Cl. CPC C08L 23/16; C08F 2/001; C08F 4/6465; C08F 210/06; C08L 23/06; C08L 23/0815; C08L 23/12; C08L 23/14; C08F 2500/12; C08L 2207/02; C08L 2207/06

(57) ABSTRACT

Composition for automotive exterior components, the composition comprising a) 30 to 45 wt.-%, based on the total weight of the composition, of a first heterophasic propylene copolymer (HECO1) having a melt flow rate MFR2 of 50 to 250 g/10 min determined according to ISO 1133 at 230° C. and 2.16 kg load, a soluble fraction (SF) content of 6 to 22 wt.-% based on the total weight of the first heterophasic propylene copolymer (HECO1) as determined according to the CRYSTEX method, and an ethylene content C2(SF) of 15 to 30 wt.-% based on the total weight of the soluble fraction (SF) of the heterophasic propylene copolymer (HECO1) as determined by Fourier transform infrared spectroscopy (FTIR) calibrated with ¹³C-NMR spectroscopy, b) 15 to 30 wt.-%, based on the total weight of the composition, of a second heterophasic propylene copolymer (HECO2) having an MFR2 of 5 to 15 g/10 min determined according to ISO 1133 at 230° C. and 2.16 kg load, a soluble fraction (SF) content of 25 to 45 wt.-% based on the second heterophasic propylene copolymer (HECO2) as determined according to the CRYSTEX method, and an ethylene content C2(SF) of more than 30 to 50 wt.-% based on the total weight of the soluble fraction (SF) of the heterophasic propylene copolymer (HECO2) as determined by Fourier transform infrared spectroscopy (FTIR) calibrated with ¹³C-NMR spectroscopy, c) 8 to 18 wt.-%, based on the total weight of the composition, of an ethylene copolymer having a density of 860 to 880 kg/m³ determined according to ISO 1183, and an MFR2 of 0.1 to 3.0 g/10 min determined according to ISO 1133 at 190° C. and 2.16 kg load, and d) 15 to 30 wt.-%, based on the total weight of the composition, of an inorganic filler.

The present invention concerns a composition for automotive exterior components, an article comprising the composition and the use of the composition for improving the adhesion of paint.

In the field of automotive applications, polyolefins such as polypropylenes are the material of choice as they can be tailored to specific purposes needed. For instance, heterophasic polypropylenes are widely used in the automobile industry, for instance in bumper applications, as they combine good stiffness with reasonable impact strength.

However, the surface of molded articles obtained from heterophasic polypropylene compositions is rather smooth having a low polarity resulting in unfavorable prerequisites for interactions with a coating material. Thus, for demanding applications like automotive parts, in particular exterior automotive parts, a pre-treatment as well as the application of an adhesion promoting layer (primer) is typically required to ensure proper paint adhesion. However, due to environmental and economic reasons it is desired to reduce the use of primers to a minimum, preferably to avoid the use of primers at all.

EP 3 336 109 A1 discloses a polypropylene composition with excellent paint adhesion and a molded article comprising the composition. The polypropylene composition comprises as a major part a first heterophasic propylene copolymer in an amount of from 62 to 85 wt.-% based on the total weight of the polypropylene composition, and further comprises a second heterophasic propylene copolymer as well as an inorganic filler. The respective compositions are, however, insufficient in stiffness for some applications.

WO 2014/191211 A1 is directed to a stiff polypropylene composition suitable for primerless painting. A polypropylene composition is provided which comprises a heterophasic propylene copolymer having an MFR2 (230° C., 2.16 kg) of 10 to 40 g/10 min, 5 to 70 wt.-% of a polypropylene homopolymer and 20 to 40 wt.-% of a filler. The respective compositions, however, suffer from insufficient impact strength for some applications.

Thus, it is an object of the present invention is to provide a composition which enables a skilled person to produce articles, such as molded or injection molded articles, having a good stiffness, good impact strength and at the same time good paint adhesion, without the necessity to apply adhesion promoters such as primers.

It now has been surprisingly found that above-mentioned objects can be achieved by providing a composition, preferably a polypropylene composition, preferably for automotive exterior components, the composition comprising, or consisting of,
a) 30 to 45 wt.-%, based on the total weight of the composition, of a first heterophasic propylene copolymer (HECO1) having
a melt flow rate MFR2 of 70 to 250 g/10 min determined according to ISO 1133 at 230° C. and 2.16 kg load,
a soluble fraction (SF) content of 6 to 22 wt.-% based on the total weight of the first heterophasic propylene copolymer (HECO1) as determined according to the CRYSTEX method, and
an ethylene content C2(SF) of 15 to 30 wt.-% based on the total weight of the soluble fraction (SF) of the heterophasic propylene copolymer (HECO1) as determined by Fourier transform infrared spectroscopy (FTIR) calibrated with ¹³C-NMR spectroscopy,
b) 15 to 30 wt.-%, based on the total weight of the composition, of a second heterophasic propylene copolymer (HECO2) having
an MFR2 of 5 to 15 g/10 min determined according to ISO 1133 at 230° C. and 2.16 kg load,
a soluble fraction (SF) content of 25 to 45 wt.-% based on the second heterophasic propylene copolymer (HECO2) as determined according to the CRYSTEX method, and
an ethylene content C2(SF) of more than 30 to 50 wt.-% based on the total weight of the soluble fraction (SF) of the heterophasic propylene copolymer (HECO2) as determined by Fourier transform infrared spectroscopy (FTIR) calibrated with ¹³C-NMR spectroscopy,
c) 8 to 18 wt.-%, based on the total weight of the composition, of an ethylene copolymer having
a density of 860 to 880 kg/m³ determined according to ISO 1183, and
an MFR2 of 0.1 to 3.0 g/10 min determined according to ISO 1133 at 190° C. and 2.16 kg load,
d) 15 to 30 wt.-%, based on the total weight of the composition, of an inorganic filler,

wherein the composition has an MFR2 of 15 to 30 g/10 min determined according to ISO 1133 at 230° C. and 2.16 kg load.

The present invention is based on the surprising finding that a specific first heterophasic propylene copolymer as described herein is used in a composition leading to the surprising balance of improved paint adhesion, stiffness and impact strength.

The present invention offers a number of advantages. The use of polypropylene based compositions according to the invention for exterior and interior parts in the automotive sector allow not only weight reduction and design freedom at a generally acceptable cost level. Also, the paintability or the adhesion of paint of parts formed from the composition according to the invention with the more recent two-layer primerless paint system is significantly improved, which is especially useful for automotive exterior parts.

The expression “polypropylene homopolymer” as used herein relates to a polypropylene that consists substantially, i.e. of at least 99.5 wt.-%, preferably at least 99.7 wt.-%, more preferably of at least 99.8 wt.-%, of propylene units. In a preferred embodiment, only propylene units in the propylene homopolymer are detectable.

The “modality” of a polymer refers to the form of its molecular weight distribution curve, i.e. the appearance of the graph of the polymer weight fraction as function of its molecular weight. If the polymer is produced in a sequential step process, utilizing reactors coupled in series and using different conditions in each reactor, the different fractions produced in the different reactors will each have their own molecular weight distribution. When the molecular weight distribution curves from these fractions are superimposed into the molecular weight distribution curve for the total resulting polymer product, that curve will show two or more maxima or at least be distinctly broadened in comparison with the curves for the individual fractions. Such a polymer product, produced in two or more serial steps, is called bimodal or multimodal depending on the number of steps. In the following all polymers thus produced in two or more sequential steps are called “multimodal”. It is noted that also the chemical compositions of the different fractions may be different.

### COMPOSITION

The composition has a moderate melt flow rate MFR2. The composition has an MFR2 of 15 to 30 g/10 min, preferably 18 to 28 g/10 min determined according to ISO 1133 at 230° C. and 2.16 kg load.

Preferably, the composition has a flexural modulus in the range of 1750 to 2750 MPa, more preferably in the range of 1800 to 2600 MPa determined according to ISO 178 on injection molded specimens.

Preferably, the composition has a Charpy notched impact strength (NIS) at 23° C. in the range of more than 30 to 85 kJ/m², more preferably in the range of 35 to 75 kJ/m² determined according to ISO 179/eA on injection molded specimens.

The composition comprises two different heterophasic propylene copolymers (HECO), namely a first heterophasic propylene copolymer (HECO1) as component a) and a second heterophasic propylene copolymer (HECO2) as component b).

### First Heterophasic Propylene Copolymer (HECO1)

The first heterophasic propylene copolymer (HECO1) is present in an amount of 30 to 45 wt.-%, preferably 33 to 42 wt.-%, more preferably 35 to 40 wt.-%, based on the total weight of the composition.

The first heterophasic propylene copolymer (HECO1) has a melt flow rate MFR2 of 70 to 250 g/10 min, preferably 70 to 200 g/10 min, preferably of 75 to 150 g/10 min, more preferably of 80 to 120 g/10 min, determined according to ISO 1133 at 230° C. and 2.16 kg load.

The first heterophasic propylene copolymer (HECO1) has a soluble fraction (SF) content of 6 to 22 wt.-%, preferably of 7 to 20 wt.-%, more preferably of 8 to 18 wt.-% based on the total weight of the first heterophasic propylene copolymer (HECO1) as determined according to the CRYSTEX method.

Accordingly, the first heterophasic propylene copolymer (HECO1) has a crystalline fraction (CF) content of 78 to 94 wt.-%, preferably of 80 to 93 wt.-%, and more preferably of 82 to 92 wt.-% based on the total weight of the first heterophasic propylene copolymer (HECO1) as determined according to the CRYSTEX method.

The first heterophasic propylene copolymer (HECO1) has an ethylene content C2(SF) of 15 to 30 wt.-%, preferably of 18 to 28 wt.-%, more preferably 20 to 26 wt.-% based on the total weight of the soluble fraction (SF) of the heterophasic propylene copolymer (HECO1) as determined by Fourier transform infrared spectroscopy (FTIR) calibrated with ¹³C-NMR spectroscopy,

Preferably, the first heterophasic propylene copolymer (HECO1) has a melting temperature Tm in the range of 145 to 160° C., more preferably in the range of 148 to 158° C., determined by differential scanning calorimetry (DSC) according to ISO 11357, and/or

an intrinsic viscosity of the soluble fraction (IV(SF)) preferably of 2.2 to 3.2 dl/g as determined in decalin according to ISO 1628-3.

Preferably, the first heterophasic propylene copolymer (HECO1) has a ratio ((IV(SF)/(IV(CF)) of intrinsic viscosity of the soluble fraction (IV(SF)) to the intrinsic viscosity of the crystalline fraction (IV(CF)) of larger than 1.8 to 4.0, more preferably of 2.2 to 2.5 as determined in decalin according to ISO 1628-3.

The first heterophasic propylene copolymer (HECO1) comprises a fraction soluble in cold xylene at 25° C. (XCS fraction) in an amount preferably in the range of 6 to 22 wt.-%, more preferably in the range of 7 to 20 wt.-%, and most preferably in the range of 8 to 18 wt.-%, based on the total weight of the first heterophasic propylene copolymer (HECO1), and/or

the first heterophasic propylene copolymer (HECO1) has a total ethylene content (C2 total) preferably in the range of 1.8 to 6.5 wt.-%, more preferably in the range of 1.9 to 6.0 wt.-%, and most preferably in the range of 2.0 to 5.5 wt.-% based on the total weight of the first heterophasic propylene copolymer (HECO1) as determined by Fourier transform infrared spectroscopy (FTIR) calibrated with ¹³C-NMR spectroscopy.

Preferably, the fraction soluble in cold xylene at 25° C. (XCS fraction) of the first heterophasic propylene copolymer (HECO1) has an intrinsic viscosity (IV(XCS)) of 1.8 to 3.2 dl/g, preferably of 2.0 to 3.0 dl/g and most preferably of 2.2 to 2.8 dl/g as determined in decalin according to ISO 1628-3.

The first heterophasic propylene copolymer (HECO1) comprises, or consists of, a matrix phase (A) and a disperse phase (B) dispersed within the matrix phase (A).

### Matrix Phase (A)

The matrix phase (A) can be unimodal or multimodal, e.g. bimodal. The matrix phase (A) preferably comprises, or consists of, a propylene copolymer or a propylene homopolymer, more preferably the matrix phase (A) comprises, or consists of, a propylene homopolymer.

Preferably, the matrix phase (A) of first heterophasic propylene copolymer (HECO1) is bimodal, more preferably the matrix phase (A) of first heterophasic propylene copolymer (HECO1) is bimodal and comprises, or consists of, a first propylene polymer fraction and a second propylene polymer fraction.

The matrix phase (A), preferably the bimodal matrix phase (A), of the first heterophasic propylene copolymer (HECO1) has a melt flow rate MFR2 of preferably 100 to 500 g/10 min, more preferably 120 to 400 g/10 min, more preferably 140 to 200 g/10 min, determined according to ISO 1133 at 230° C. and 2.16 kg load.

The matrix phase (A), preferably the bimodal matrix phase (A), of the first heterophasic propylene copolymer (HECO1) comprises a fraction soluble in cold xylene at 25° C. (XCS fraction) in an amount preferably in the range of more than 0 to less than 2.0 wt.-%, more preferably in the range of 0.30 to 1.80 wt.-%, based on the total weight of the matrix phase (A) of the first heterophasic propylene copolymer (HECO1).

### Disperse Phase (B)

The disperse phase (B) comprises, or consists of, a copolymer of propylene and a comonomer selected from alpha-olefins having 2 or 4 to 12 carbon atoms as comonomer, preferably alpha-olefins having 2 or 4 to 10 carbon atoms, more preferably ethylene, 1-butene and/or 1-hexene, even more preferably ethylene and/or 1-butene and most preferably ethylene as comonomer. Thus, most preferably the disperse phase (B) comprises, or consists of, a copolymer of propylene and ethylene. Such a copolymer of propylene and ethylene is also called an ethylene-propylene rubber (EPR).

Preferably, disperse phase (B) comprises comonomer units in an amount of at most 60 mol-%, preferably in the range of 35 to 60 mol-%, more preferably in the range of 45 to 55 mol-% based on the total amount of disperse phase (B).

### Preparation of HEC01

The first heterophasic propylene copolymer (HECO1) is preferably produced in a multistage process. Preferably, the first heterophasic propylene copolymer (HECO1) comprising, or consisting of, the matrix phase (A) and the disperse phase (B) dispersed within the matrix phase (A) is obtained by a process, the process comprising the steps of
a) preparing the matrix phase (A) of the first heterophasic propylene copolymer by
a1) polymerising in a first reactor propylene to obtain a first propylene polymer fraction,
a2) transferring the first propylene polymer fraction to a second reactor, and polymerising in the second reactor propylene to obtain a second propylene polymer fraction,
b) preparing the disperse phase (B) of the first heterophasic propylene copolymer by
b1) transferring the first propylene polymer fraction and the second propylene polymer fraction to a third reactor, and polymerising in the third reactor propylene and an alpha-olefin having 2 or 4 to 10 carbon atoms, preferably an alpha-olefin having two carbon atoms, to obtain a third propylene polymer fraction,

wherein polymerizing in steps a1), a2) and b1) is conducted in the presence of a metallocene catalyst system as described below.

The first reactor is preferably a slurry phase reactor, such as a loop reactor. It is preferred that the operating temperature in the first reactor, preferably the loop reactor, is in the range from 62 to 85° C., more preferably in the range from 65 to 82° C., still more preferably in the range from 67 to 80° C.

Typically, the pressure in the first reactor, preferably in the loop reactor, is in the range from 20 to 80 bar, preferably 30 to 70 bar, like 35 to 65 bar.

It is preferred that in the first reactor, preferably the loop reactor, a propylene homopolymer is produced. Thus, it is preferred that the first propylene polymer fraction is a propylene homopolymer fraction.

Preferably hydrogen is added in the first reactor in order to control the molecular weight, i.e. the melt flow rate MFR2. Preferably, in step a1) a ratio of the feed of hydrogen to the feed of propylene is 0.1 to 0.5 mol/kmol, preferably 0.15 to 0.45 mol/kmol, and most preferably 0.2 to 0.4 mol/kmol.

The average residence time in the first reactor, preferably the loop reactor, is typically from 15 to 120 min, preferably from 20 to 80 min. As it is well known in the art the average residence time T can be calculated from equation (1) below:

$$τ = \frac{{V}_{R}}{{Q}_{o}} \qquad equation ( 1 )$$

wherein

V_{R} is the volume of the reaction space (in case of a loop reactor, the volume of the reactor, in case of the fluidized bed reactor, the volume of the fluidized bed)

Qₒ is the volumetric flow rate of the product stream (including the polymer product and the fluid reaction mixture).

The production rate is suitably controlled by the catalyst feed rate and temperature. It is also possible to influence the production rate by suitable selection of the monomer concentration. The desired monomer concentration can then be achieved by suitably adjusting the propylene feed rate.

The second reactor preferably is a first gas phase reactor, such as a first fluidized bed gas phase reactor. It is preferred that the operating temperature in the second reactor, preferably the first gas phase reactor, is in the range from 75 to 95° C., more preferably in the range from 78 to 92° C. Preferably, the pressure in the second reactor, preferably in the first gas phase reactor, is in the range from 5 to 50 bar, preferably 15 to 40 bar.

The average residence time in the second reactor, preferably the first gas phase reactor, is typically 30 to 130 min. Reference is made to equation (1) above.

It is preferred that in the second reactor, preferably the first gas phase reactor, a propylene homopolymer is produced. Thus, it is preferred that the second propylene polymer fraction is a propylene homopolymer fraction.

Preferably hydrogen is added in the second reactor in order to control the molecular weight, i.e. the melt flow rate MFR2. Preferably the hydrogen to propylene ratio (H2/C3 ratio) in the second reactor, preferably the first gas phase reactor, is in the range from 2.0 to 8.5 mol/kmol, more preferably 3.0 to 7.5 mol/kmol.

The third reactor preferably is a second gas phase reactor, such as a second fluidized bed gas phase reactor. It is preferred that the operating temperature in the third reactor, preferably the second gas phase reactor, is in the range from 65 to 85° C., more preferably in the range from 68 to 82° C. Typically, the operating temperature in third reactor is lower than the operating temperature in the second reactor. Typically, the pressure in the third reactor, preferably in the second gas phase reactor, is in the range from 5 to 50 bar, preferably 15 to 40 bar.

The average residence time in the third reactor, preferably the second gas phase reactor, is typically 30 to 130 min. Reference is made to equation (1) above.

In the third reactor, preferably the second gas phase reactor, the disperse phase (B) of the first heterophasic propylene copolymer (HECO1) is produced, i.e. a copolymer of propylene and a comonomer selected from alpha-olefins having 2 or 4 to 12 carbon atoms as comonomer, preferably alpha-olefins having 2 or 4 to 10 carbon atoms, more preferably ethylene, 1-butene and/or 1-hexene, even more preferably ethylene and/or 1-butene and most preferably ethylene as comonomeris produced. Preferably, in the third reactor, preferably the second gas phase reactor, a propylene ethylene copolymer is produced. Thus, the third propylene polymer fraction is a propylene ethylene copolymer fraction.

The ethylene to propylene ratio (C2/C3 ratio) in the third reactor, preferably the second gas phase reactor, is in the range from 700 to 1000 mol/kmol, more preferably 800 to 950 mol/kmol.

Preferably, the hydrogen to ethylene ratio (H2/C2 ratio) in the third reactor, preferably the second gas phase reactor, is in the range from 0.5 to 3.5 mol/kmol, more preferably 1.0 to 2.5 mol/kmol.

The combined first, second and third propylene polymer fractions preferably form the first heterophasic propylene copolymer (HECO1).

A preferred multistage process is the above-identified slurry-gas phase process, such as developed by Borealis and known as the Borstar® technology. In this respect, reference is made to the EP applications EP 0 887 379 A1 and EP 0517 868 A1.

The preparation of the first, second and third propylene polymer fractions can comprise in addition to the (main) polymerization stages in the at least three reactors prior thereto a pre-polymerization in a pre-polymerization reactor upstream of the first reactor.

In the pre-polymerization reactor, a polypropylene is produced. The pre-polymerization is conducted in the presence of the metallocene catalyst system. However, this shall not exclude the option that at a later stage for instance further cocatalyst is added in the polymerization process, for instance in the first reactor. In one embodiment, all components of the metallocene catalyst system are only added in the pre-polymerization reactor, if a pre-polymerization is applied. The pre-polymerization reaction is typically conducted at a temperature of 0 to 60° C., preferably from 15 to 50° C., and more preferably from 20 to 45° C. The pressure in the pre-polymerization reactor is not critical but must be sufficiently high to maintain the reaction mixture in liquid phase. Thus, the pressure may be from 20 to 100 bar, for example 30 to 70 bar. The average residence time in the pre-polymerization reactor is typically 15 to 45 min. Reference is made to equation (1) above.

In a preferred embodiment, the pre-polymerization is conducted as bulk slurry polymerization in liquid propylene, i.e. the liquid phase mainly comprises propylene, with optionally inert components dissolved therein.

It is possible to add other components also to the pre-polymerization stage. Thus, hydrogen may be added into the pre-polymerization stage to control the molecular weight of the polypropylene as is known in the art. The precise control of the pre-polymerization conditions and reaction parameters is within the skill of the art.

Due to the above defined process conditions in the pre-polymerization, preferably a mixture of the metallocene catalyst system and the polypropylene produced in the pre-polymerization reactor is obtained. Preferably, metallocene catalyst system is (finely) dispersed in the polypropylene. In other words, the metallocene catalyst particles introduced in the pre-polymerization reactor are split into smaller fragments that are evenly distributed within the growing polypropylene. The sizes of the introduced metallocene catalyst particles as well as of the obtained fragments are not of essential relevance for the instant invention and within the skilled knowledge.

As mentioned above, if a pre-polymerization is used, subsequent to said pre-polymerization, the mixture of the metallocene catalyst system and the polypropylene produced in the pre-polymerization reactor is transferred to the first reactor. Typically the total amount of the polypropylene produced in the pre-polymerization reactor in the first, second and third propylene polymer fractions is rather low and typically not more than 5.0 wt.-%, more preferably not more than 4.0 wt.-%, still more preferably in the range from 0.1 to 4.0 wt.-%, like in the range 0.5 of to 3.0 wt.-%.

In case that pre-polymerization is not used, propylene and the other ingredients such as the metallocene catalyst system are directly introduced into the first reactor.

### Metallocene Catalyst System

The first heterophasic propylene copolymer (HECO1) is prepared in the presence of at least one metallocene catalyst system.

The metallocene catalyst system may be any supported metallocene catalyst system suitable for the production of heterophasic propylene copolymers.

It is preferred that the metallocene catalyst system comprises (i) a metallocene complex, (ii) a cocatalyst system comprising a boron-containing cocatalyst and/or aluminoxane cocatalyst, and (iii) a support, preferably a support comprising or consisting of silica.

It is preferred that the metallocene catalyst system comprises
(i) a metallocene complex of formula (I):

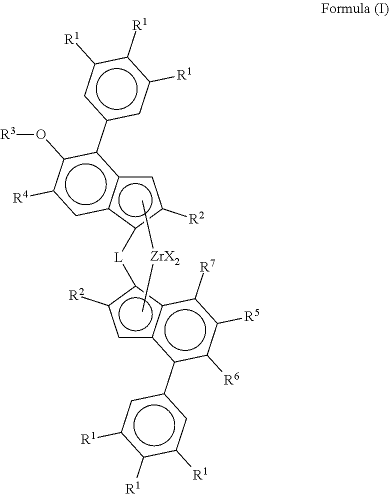

wherein each X independently is a sigma-donor ligand,

L is a divalent bridge selected from -R′₂C—, -R′₂C—CR′₂—, -R′₂Si—, -R′₂Si-SiR′₂—, —R′₂Ge—, wherein each R′ is independently a hydrogen atom or a C₁-C₂₀-hydrocarbyl group optionally containing one or more heteroatoms from groups 14-16 of the periodic table or fluorine atoms, or optionally two R′ groups taken together can form a ring,

each R¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group, and optionally two adjacent R¹ groups can be part of a ring including the phenyl carbons to which they are bonded,

each R² independently are the same or can be different and are a CH₂-R⁸ group, with R⁸ being H or linear or branched C₁₋₆-alkyl group, C₃₋₈-cycloalkyl group, C₆₋₁₀-aryl group,

R³ is a linear or branched C₁-C₆-alkyl group, C₇₋₂₀-arylalkyl, C₇₋₂₀-alkylaryl group or C₆-C₂₀-aryl group,

R⁴ is a C(R⁹)₃ group, with R⁹ being a linear or branched C₁-C₆-alkyl group,

R⁵ is hydrogen or an aliphatic C₁-C₂₀-hydrocarbyl group optionally containing one or more heteroatoms from groups 14-16 of the periodic table;

R⁶ is hydrogen or an aliphatic C₁-C₂₀-hydrocarbyl group optionally containing one or more heteroatoms from groups 14-16 of the periodic table; or

R⁵ and R⁶ can be taken together to form a 5 membered saturated carbon ring which is optionally substituted by n groups R¹⁰, n being from 0 to 4;

each R¹⁰ is same or different and may be a C₁-C₂₀-hydrocarbyl group, or a C₁-C₂₀-hydrocarbyl group optionally containing one or more heteroatoms belonging to groups 14-16 of the periodic table;

R⁷ is H or a linear or branched C₁-C₆-alkyl group or an aryl or heteroaryl group having 6 to 20 carbon atoms optionally substituted by one to three groups R¹¹,

each R¹¹ are independently the same or can be different and are hydrogen, a linear or branched C₁-C₆-alkyl group, a C₇₋₂₀-arylalkyl, C₇₋₂₀-alkylaryl group or C₆₋₂₀-aryl group or an OY group, wherein Y is a C₁₋₁₀-hydrocarbyl group,
(ii) a cocatalyst system comprising a boron-containing cocatalyst and/or aluminoxane cocatalyst, and
(iii) a support, preferably a support comprising or consisting of silica.

The term “sigma-donor ligand” is well understood by the person skilled in the art, i.e. a group bound to the metal via a sigma bond. Thus the anionic ligands “X” can independently be halogen or be selected from the group consisting of R′, OR′, SiR′3, OSiR′₃, OSO₂CF₃, OCOR′, SR′, NR′₂ or PR′₂ group wherein R′ is independently hydrogen, a linear or branched, cyclic or acyclic, C₁ to C₂₀ alkyl, C₂ to C₂₀ alkenyl, C₂ to C₂₀ alkynyl, C₃ to C₁₂ cycloalkyl, C₆ to C₂₀ aryl, C₇ to C₂₀ arylalkyl, C₇ to C₂₀ alkylaryl, C₈ to C₂₀ arylalkenyl, in which the R′ group can optionally contain one or more heteroatoms belonging to groups 14 to 16.

In a preferred embodiment the anionic ligands “X” are identical and either halogen, like C₁, or methyl or benzyl. A preferred monovalent anionic ligand is halogen, in particular chlorine (Cl).

More information, in particular about the preparation of such a catalyst, can be found e.g. in WO 2013/007650 A1.

Preferred metallocene complexes (i) of the metallocene catalyst include:
rac-dimethylsilanediylbis[2-methyl-4-(3′, 5′-dimethylphenyl)-5-methoxy-6-tert-butylinden-1-yl]zirconium dichloride,
rac-anti-dimethylsilanediyl[2-methyl-4-(4′-tert-butylphenyl)-inden-1-yl][2-methyl-4-(4′-tertbutylphenyl)-5-methoxy-6-tert-butylinden-1-yl]zirconium dichloride,
rac-anti-dimethylsilanediyl[2-methyl-4-(4′-tert-butylphenyl)-inden-1-yl][2-methyl-4-phenyl-5-methoxy-6-tert-butylinden-1-yl]zirconium dichloride,
rac-anti-dimethylsilanediyl[2-methyl-4-(3′,5′-tert-butylphenyl)-1,5,6,7-tetrahydro-sindacen-1-yl][2-methyl-4-(3′,5′-dimethyl-phenyl)-5-methoxy-6-tert-butylinden-1-yl]zirconium dichloride,
rac-anti-dimethylsilanediyl[2-methyl-4,8-bis-(4′-tert-butylphenyl)-1,5,6,7-tetrahydro-sindacen-1-yl][2-methyl-4-(3′,5′-dimethyl-phenyl)-5-methoxy-6-tert-butylinden-1-yl]zirconium dichloride,
rac-anti-dimethylsilanediyl[2-methyl-4,8-bis-(3′,5′-dimethylphenyl)-1,5,6,7-tetrahydro-s-indacen-1-yl][2-methyl-4-(3′,5′-dimethylphenyl)-5-methoxy-6-tert-butylinden-1-yl]zirconium dichloride,
rac-anti-dimethylsilanediyl[2-methyl-4,8-bis-(3′,5′-dimethylphenyl)-1,5,6,7-tetrahydro-s-indacen-1-yl][2-methyl-4-(3′,5′-5 ditert-butyl-phenyl)-5-methoxy-6-tert-butylinden-1-yl]zirconium dichloride,

or their corresponding zirconium dimethyl analogues.

Especially preferred is rac-anti-dimethylsilanediyl[2-methyl-4,8-bis-(3′,5′-dimethylphenyl)-1,5,6,7-tetrahydro-s indacen-1-yl][2-methyl-4-(3′,5′-dimethylphenyl)-5-methoxy-6-tert-butylinden-1-yl]zirconium dichloride.

Also especially preferred, the metallocene catalyst system comprises a metallocene complex (i) of formula (II):

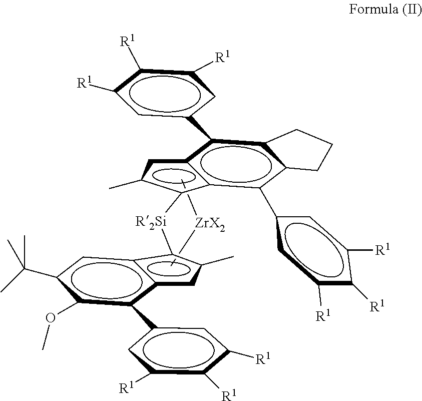

wherein each R¹ are independently the same or can be different and are hydrogen or a linear or branched C₁-C₆ alkyl group, whereby at least on R¹ per phenyl group is not hydrogen,

R′ is a C₁-C₁₀ hydrocarbyl group, preferably a C₁-C₄ hydrocarbyl group and more preferably a methyl group and X independently is a hydrogen atom, a halogen atom, C₁-C₆ alkoxy group, C₁-C₆ alkyl group, phenyl or benzyl group.

Most preferably, X is chlorine, benzyl or a methyl group. Preferably, both X groups are the same. The most preferred options are two chlorides, two methyl or two benzyl groups, especially two chlorides.

Especially preferred is rac-anti-dimethylsilanediyl[2-methyl-4,8-bis-(3′,5′-dimethylphenyl)-1,5,6,7-tetrahydro-s-indacen-1-yl][2-methyl-4-(3′,5′-dimethylphenyl)-5-methoxy-6-tert-butylinden-1-yl]zirconium dichloride according to formula (III):

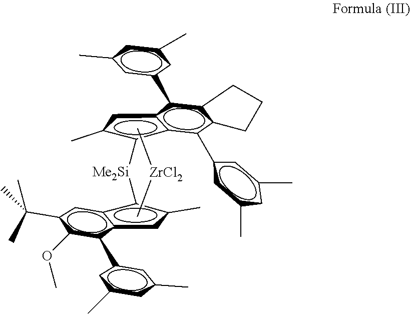

The ligands require to form the complexes an hence catalysts of the invention can be synthesized by any process and the skilled organic chemist would be able to devise various synthetic protocols for the manufacture of the necessary ligand materials. For example WO 2007/116034 discloses the necessary chemistry. Synthetic protocols can also generally be found in WO 2002/02576, WO 2011/135004, WO 2012/084961, WO 2012/001052, WO 2011/076780, WO 2015/158790 and WO 2018/122134. Especially reference is made to WO 2019/179959 in which the most preferred catalyst of the present invention is described.

### Cocatalyst System

To form an active catalytic species it is normally necessary to employ a cocatalyst as is well known in the art. A cocatalyst system (ii) comprising a boron containing cocatalyst and/or an aluminoxane cocatalyst is used in combination with the above defined metallocene complex (i).

The aluminoxane cocatalyst can be one of formula (IV):

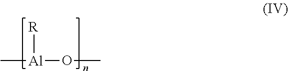

where n is usually from 6 to 20 and R has the meaning below.

Aluminoxanes are formed on partial hydrolysis of organoaluminum compounds, for example those of the formula AlR₃, AlR₂Y and Al₂R₃Y₃ where R can be, for example, C₁-C₁₀ alkyl, preferably C₁-C₅ alkyl, or C₃-C₁₀ cycloalkyl, C₇-C₁₂ arylalkyl or alkylaryl and/or phenyl or naphthyl, and where Y can be hydrogen, halogen, preferably chlorine or bromine, or C₁-C₁₀ alkoxy, preferably methoxy or ethoxy. The resulting oxygen-containing aluminoxanes are not in general pure compounds but mixtures of oligomers of the formula (IV).

The preferred aluminoxane is methylaluminoxane (MAO). Since the aluminoxanes used according to the invention as cocatalysts are not, owing to their mode of preparation, pure compounds, the molarity of aluminoxane solutions hereinafter is based on their aluminium content.

Also a boron containing cocatalyst can be used instead of the aluminoxane cocatalyst or the aluminoxane cocatalyst can be used in combination with a boron containing cocatalyst.

It will be appreciated by the person skilled in the art that where boron based cocatalysts are employed, it is normal to pre-alkylate the complex by reaction thereof with an aluminium alkyl compound, such as TIBA. This procedure is well known and any suitable aluminium alkyl, e.g. Al(C₁-C₆ alkyl)₃ can be used.

Preferred aluminium alkyl compounds are triethylaluminium, tri-isobutylaluminium, tri-isohexylaluminium, tri-n-octylaluminium and tri-isooctylaluminium.

Alternatively, when a borate cocatalyst is used, the metallocene complex is in its alkylated version, that is for example a dimethyl or dibenzyl metallocene complex can be used.

Boron based cocatalysts of interest include those of formula (V)

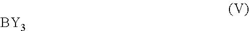

wherein Y is the same or different and is a hydrogen atom, an alkyl group of from 1 to about carbon atoms, an aryl group of from 6 to about 15 carbon atoms, alkylaryl, arylalkyl, haloalkyl or haloaryl each having from 1 to 10 carbon atoms in the alkyl radical and from 6-20 carbon atoms in the aryl radical or fluorine, chlorine, bromine or iodine. Preferred examples for Y are methyl, propyl, isopropyl, isobutyl or trifluoromethyl, unsaturated groups such as aryl or haloaryl like phenyl, tolyl, benzyl groups, p-fluorophenyl, 3,5-difluorophenyl, pentachlorophenyl, pentafluorophenyl, 3,4,5-trifluorophenyl and 3,5-di(trifluoromethyl)phenyl. Preferred options are trifluoroborane, triphenylborane, tris(4-fluorophenyl)borane, tris(3,5-difluorophenyl)borane, tris(4-fluoromethylphenyl)borane, tris(2,4,6-trifluorophenyl)borane, tris(penta-fluorophenyl)borane, tris(tolyl)borane, tris(3,5-dimethyl-phenyl)borane, tris(3,5-difluorophenyl)borane and/or tris(3,4,5-trifluorophenyl)borane.

Particular preference is given to tris(pentafluorophenyl)borane.

However it is preferred that borates are used, i.e. compounds containing a borate 3+ ion.

Such ionic cocatalysts preferably contain a non-coordinating anion such as tetrakis(pentafluorophenyl)borate and tetraphenylborate. Suitable counterions are protonated amine or aniline derivatives such as methylammonium, anilinium, dimethylammonium, diethylammonium, N-methylanilinium, diphenylammonium, N,N-dimethylanilinium, trimethylammonium, triethylammonium, tri-n-butylammonium, methyldiphenylammonium, pyridinium, p-bromo-N,N-dimethylanilinium or p-nitro-N,N-dimethylanilinium.

Preferred ionic compounds which can be used according to the present invention include:
triethylammoniumtetra(phenyl)borate, tributylammoniumtetra(phenyl)borate,
trimethylammoniumtetra(tolyl)borate, tributylammoniumtetra(tolyl)borate,
tributylammoniumtetra(pentafluorophenyl)borate,
tripropylammoniumtetra(dimethylphenyl)borate,
tributylammoniumtetra(trifluoromethylphenyl)borate, tributylammoniumtetra(4-fluorophenyl)borate, N,N-dimethylcyclohexylammoniumtetrakis(pentafluorophenyl)borate, N,N-dimethylbenzylammoniumtetrakis(pentafluorophenyl)borate, N,N-dimethylaniliniumtetra(phenyl)borate, N,N-diethylaniliniumtetra(phenyl)borate,
N,N-dimethylaniliniumtetrakis(pentafluorophenyl)borate, N,N-di(propyl)ammoniumtetrakis(pentafluorophenyl)borate,
di(cyclohexyl)ammoniumtetrakist(pentafluorophenyl)borate,
triphenylphosphoniumtetrakis(phenyl)borate,
triethylphosphoniumtetrakis(phenyl)borate,
diphenylphosphoniumtetrakis(phenyl)borate,
tri(methylphenyl)phosphoniumtetrakis(phenyl)borate,
tri(dimethylphenyl)phosphoniumtetrakis(phenyl)borate,
triphenylcarbeniumtetrakis(pentafluorophenyl)borate, or
ferroceniumtetrakis(pentafluorophenyl)borate.

Preference is given to triphenylcarbeniumtetrakis(pentafluorophenyl) borate, N,N-dimethylcyclohexylammoniumtetrakis(pentafluorophenyl)borate or N,N-dimethylbenzylammoniumtetrakis(pentafluorophenyl)borate.

It has been surprisingly found that certain boron cocatalysts are especially preferred.

Preferred borates of use in the invention therefore comprise the trityl ion. Thus the use of N,N-dimethylammonium-tetrakispentafluorophenylborate and Ph₃CB(PhF₅)₄ and analogues therefore are especially favoured.

According to the present invention, the preferred cocatalysts are aluminoxanes, more preferably methylaluminoxanes, combinations of aluminoxanes with Al-alkyls, boron or borate cocatalysts, and combination of aluminoxanes with boron-based cocatalysts.

Suitable amounts of cocatalyst will be well known to the person skilled in the art.

The molar ratio of boron to the metal ion of the metallocene may be in the range 0.5:1 to 35 10:1 mol/mol, preferably 1:1 to 10:1 mol/mol, especially 1:1 to 5:1 mol/mol.

The molar ratio of Al in the aluminoxane to the metal ion of the metallocene may be in the range 1:1 to 2000:1 mol/mol, preferably 10:1 to 1000:1 mol/mol, and more preferably 50:1 to 500:1 mol/mol.

The metallocene catalyst system used in the polymerisation process of the present invention is used in supported form. The support (iii) used comprises, preferably consists of, silica. In other words, the support is preferably a silica support. The person skilled in the art is aware of the procedures required to support a metallocene catalyst.

Especially preferably, the support is a porous material so that the metallocene complex may be loaded into the pores of the support, e.g. using a process analogous to those described in WO 94/14856 (Mobil), WO 95/12622 (Borealis) and WO 2006/097497.

The average particle size of the support can be typically from 10 to 100 μm. However, it has turned out that special advantages can be obtained if the support has an average particle size from 15 to 80 μm, preferably from 18 to 50 μm.

The particle size distribution of the support is described in the following. The silica support preferably has a D50 of between 10 and 80 μm, preferably 18 and 50 μm. Furthermore, the silica support preferably has a D10 of between 5 and 30 μm and a D90 of between 30 and 90 μm.

### Second Heterophasic Propylene Copolymer (HECO2)

The second heterophasic propylene copolymer (HECO2) is present in an amount of 15 to 30 wt.-%, preferably of 18 to 28 wt.-%, more preferably of 20 to 25 wt.-%, based on the total weight of the composition.

The second heterophasic propylene copolymer (HECO2) has a melt flow rate MFR2 of 5 to 15 g/10 min, preferably of 6 to 13 g/10 min determined according to ISO 1133 at 230° C. and 2.16 kg load.

The second heterophasic propylene copolymer (HECO2) has a soluble fraction (SF) content of 25 to 45 wt.-%, preferably of 27 to 40 wt.-%, more preferably of 29 to 38 wt.-% based on the total weight of the second heterophasic propylene copolymer (HECO2) as determined according to the CRYSTEX method.

The second heterophasic propylene copolymer (HECO2) has an ethylene content C₂(SF) of 30 to 50 wt.-%, preferably 32 to 45 wt.-%, more preferably 35 to 42 wt.-% based on the total weight of the soluble fraction (SF) of the second heterophasic propylene copolymer (HECO2) as determined by Fourier transform infrared spectroscopy (FTIR) calibrated with ¹³C-NMR spectroscopy,

Preferably, the second heterophasic propylene copolymer (HECO2) has an intrinsic viscosity of the soluble fraction (IV(SF)) of 3.0 to 7.0 dl/g, more preferably of 3.2 to 6.5 dl/g as determined in decalin according to ISO 1628-3 and/or a melting temperature Tm in the range of 162 to 170° C., more preferably of 164 to 168° C., determined by differential scanning calorimetry (DSC) according to ISO 11357.

### Ethylene Copolymer

The composition further comprises as a component c) an ethylene copolymer. The ethylene copolymer is preferably a plastomers. Preferably, the ethylene copolymer is present in an amount of 10 to 16 wt.-%, based on the total weight of the composition.

Preferably, the ethylene copolymer has an MFR2 of 0.3 to 2.5 g/10 min determined according to ISO 1133 at 190° C. and 2.16 kg load.

Preferably, the ethylene copolymer is a copolymer of ethylene and a comonomer selected from an alpha-olefin having 3 to 10 carbon atoms, preferably an alpha-olefin having 8 carbon atoms. In other words, the ethylene copolymer is preferably an ethylene-octene copolymer.

The amount of alpha-olefin having 3 to 10 carbon atoms, more preferably an alpha-olefin having 8 carbon atoms present in the ethylene copolymer is less than 50 mol-%, based on the total amount of ethylene copolymer.

### Inorganic Filler

The composition further comprises as a component d) an inorganic filler.

The inorganic filler is preferably a mineral filler. The inorganic filler is preferably present in an amount of 18 to 28 wt.-%, based on the total weight of the composition.

The inorganic filler, or more preferably the mineral filler, is selected from talc, wollastonite, kaolin, mica, clay or a mixture thereof, more preferably the filler is talc.

Preferably, the inorganic filler has a median particle size D50 of 5 to 20 μm determined according to ISO 13317-3 (Sedigraph).

It should be noted that the inorganic filler does not belong to the class of additives e) described herein. The inorganic filler is usually a commercially available product.

### Additive

Preferably, the composition further comprises, or further consists of,
e) 0.5 to 5.0 wt.-%, based on the total weight of the composition, of an additive.

The additive may be one compound or a mixture of two or more compounds. Preferably, the additive comprises, or consists of, one or more antioxidant(s), a UV stabilizer, an antistatic agent, an acid scavenger, a nucleating agent, carbon black or a mixture thereof. At least one additive may be added to the composition in the form of a masterbatch. Preferably, carbon black is in the form of a carbon black masterbatch.

Such additives are commercially available and for example described in “Plastic Additives Handbook”, 6th edition 2009 of Hans Zweifel (pages 1141 to 1190).

### Propylene Homopolymer

Preferably, the composition further comprises, or further consists of,
f) more than 0 wt.-% and up to 3 wt.-%, preferably 0.1 to 2.5 wt.-%, more preferably 0.5 to 2.0 wt.-%, based on the total weight of the composition, of a propylene homopolymer (PP-H).

Preferably, the propylene homopolymer (PP-H) has an MFR2 of 1 to 100 g/10 min, more preferably 1.5 to 50 g/10 min, more preferably 2 to 10 g/10 min determined according to ISO 1133 at 230° C. and 2.16 kg load.

It is noted that the propylene homopolymer f) is not, or does not correspond to, the matrix (A) of the first heterophasic propylene copolymer (HECO1) and/or of the matrix second heterophasic propylene copolymer (HECO2) described herein. In other words, the propylene homopolymer f) is preferably a compound different from the matrix (A) of the first heterophasic propylene copolymer (HECO1) a) and/or from the matrix of the second heterophasic propylene copolymer (HECO2) b) described herein.

### Article

The invention further provides an article, preferably a molded article, more preferably an injection molded article, comprising the composition according to the invention. The article, preferably the molded article, more preferably the injection molded article, is preferably an automotive exterior component or an automotive interior component. The automotive exterior component is selected from bumpers, rocker panels, body panels, side trims, step assists and spoilers.

The article, preferably the molded article, more preferably the injection molded article comprises the composition according to the invention in an amount of at least 60 wt.-%, more preferably at least 80 wt.-%, and most preferably at least 95 wt.-% based on the total weight of the article. Usually, the article, preferably the molded article, more preferably the injection molded article comprises the composition according to the invention in an amount of at most 100 wt.-% or at most 99.5 wt.-%, or at most 99 wt.-% based on the total weight of the article.

All preferred embodiments of the composition according to the invention are also preferred embodiments of the article, if applicable.

### Use

The invention also provides the use of the composition according to the invention for improving the paint adhesion. Preferably, the composition according to the invention is used for improving the paint adhesion on the surface of articles, preferably molded articles, more preferably the injection molded articles. The article, preferably the molded article, more preferably the injection molded article, is preferably an automotive exterior component or an automotive interior component. The automotive exterior component is selected from bumpers, rocker panels, body panels, side trims, step assists and spoilers. The paint adhesion is determined as a delamination area according to the paint adhesion test described herein. Preferably, the delamination area according to the paint adhesion test is less than 57 mm², more preferably less than 55 mm², more preferably less than 53 mm². Usually, the delamination area is more than 1 mm² or more than 5 mm² or more than 10 mm² or more than 20 mm².

All preferred embodiments of the composition according to the invention and the article of the invention are also preferred embodiments of the use of the invention, if applicable.

In particular, the present invention is also directed at the use of the composition according to the invention to achieve on the surface of articles, preferably molded articles, more preferably injection molded articles a delamination area according to the paint adhesion test of less than 57 mm², more preferably less than 55 mm², more preferably less than 53 mm². Usually, the delamination area is more than 1 mm² or more than 5 mm² or more than 10 mm² or more than 20 mm².

The present invention will be described by way of non-limiting examples below.

### Experimental Part

### 1. Determination Methods

The following definitions of terms and determination methods apply for the above general description of the invention as well as to the below examples unless otherwise defined.

### a) Melt Flow Rate (MFR)

The melt flow rate (MFR) was determined according to ISO 1133 and is indicated in g/10 min. The higher the melt flow rate, the lower the viscosity of the polymer. The MFR2 for polypropylene is determined at 230° C. and 2.16 kg load, and the MFR2 for polyethylene is determined at 190° C. and 2.16 kg.

The MFR2 of a fraction (B) produced in the presence of a fraction (A) is calculated using the measured values of MFR2 of the fraction (A) and the mixture received after producing fraction (B) (“final”):

$$Log ( {MFR}_{final} ) = weight fraction ( A ) * Log ( {MFR}_{A} ) + weight fraction ( B ) * Log ( {MFR}_{B} )$$

b) CRYSTEX: Determination of Crystalline and soluble fractions and their respective properties (IV and Ethylene content)

The crystalline (CF) and soluble fractions (SF) of the polypropylene compositions as well as the comonomer content and intrinsic viscosities of the respective fractions were analyzed by use of the CRYSTEX instrument, Polymer Char (Valencia, Spain). Details of the technique and the method can be found in literature (Ljiljana Jereric, Andreas Albrecht, Martina Sandholzer & Markus Gahleitner (2020) Rapid characterization of high-impact ethylene-propylene copolymer composition by crystallization extraction separation: comparability to standard separation methods, International Journal of Polymer Analysis and Characterization, 25:8, 581-596)

The crystalline and amorphous fractions are separated through temperature cycles of dissolution at 160° C., crystallization at 40° C. and re-dissolution in 1,2,4-trichlorobenzene at 160° C. Quantification of SF and CF and determination of ethylene content (C2) are achieved by means of an integrated infrared detector (IR4) and for the determination of the intrinsic viscosity (iV) an online 2-capillary viscometer is used.

The IR4 detector is a multiple wavelength detector measuring IR absorbance at two different bands (CH₃ stretching vibration (centred at app. 2960 cm⁻¹) and the CH stretching vibration (2700-3000 cm⁻¹) that are serving for the determination of the concentration and the Ethylene content in Ethylene-Propylene copolymers. The IR4 detector is calibrated with series of 8 EP copolymers with known Ethylene content in the range of 2 wt.-% to 69 wt.-% (determined by ¹³C-NMR) and each at various concentrations, in the range of 2 and 13 mg/ml. To encounter for both features, concentration and ethylene content at the same time for various polymer concentrations expected during Crystex analyses the following calibration equations were applied:

$$Conc = a + b * Abs ( CH ) + c * {( Abs ( CH ) )}^{2} + d * Abs ( {CH}_{3} ) + e * ( {Abs ( {CH}_{3} )}^{2} + f * Abs ( CH ) * Abs ( {CH}_{3} ) \qquad ( Equation 1 )$$

$${CH}_{3} / 1000 C = a + b * Abs ( CH ) + c * Abs ( {CH}_{3} ) + d * ( Abs ( {CH}_{3} ) / Abs ( CH ) ) + e * {( Abs ( {CH}_{3} ) / Abs ( CH ) )}^{2} \qquad ( Equation 2 )$$

The constants a to e for equation 1 and a to f for equation 2 were determined by using least square regression analysis.

The CH₃/1000C is converted to the ethylene content in wt.-% using following relationship:

$$wt . - \% ( Ethylene in EP Copolymers ) = 100 - {CH}_{3} / 1000 TC * 0.3 \qquad ( Equation 3 )$$

Amounts of Soluble Fraction (SF) and Crystalline Fraction (CF) are correlated through the XS calibration to the “Xylene Cold Soluble” (XCS) quantity and respectively Xylene Cold Insoluble (XCI) fractions, determined according to standard gravimetric method as per IS016152. XS calibration is achieved by testing various EP copolymers with XS content in the range 2-31 wt.-%. The determined XS calibration is linear:

$$wt . - \% XS = 1 , 01 * wt \% SF \qquad ( Equation 4 )$$

Intrinsic viscosity (iV) of the parent EP copolymer and its soluble and crystalline fractions are determined with a use of an online 2-capillary viscometer and are correlated to corresponding iV's determined by standard method in decalin according to ISO 1628-3. Calibration is achieved with various EP PP copolymers with iV=2-4 dL/g. The determined calibration curve is linear:

$$iV ( dL / g ) = a * Vsp / c \qquad ( Equation 5 )$$

The samples to be analyzed are weighed out in concentrations of 10 mg/ml to 20 mg/ml. To avoid injecting possible gels and/or polymers which do not dissolve in TCB at 160° C., like PET and PA, the weighed out sample was packed into a stainless steel mesh MW 0,077/D 0,05 mmm.

After automated filling of the vial with 1,2,4-TCB containing 250 mg/I 2,6-tert-butyl-4-methylphenol (BHT) as antioxidant, the sample is dissolved at 160° C. until complete dissolution is achieved, usually for 60 min, with constant stirring of 400 rpm. To avoid sample degradation, the polymer solution is blanketed with the N2 atmosphere during dissolution.

A defined volume of the sample solution is injected into the column filled with inert support where the crystallization of the sample and separation of the soluble fraction from the crystalline part is taking place. This process is repeated two times. During the first injection the whole sample is measured at high temperature, determining the iV [dl/g] and the C₂ [wt.-%] of the PP composition. During the second injection the soluble fraction (at low temperature) and the crystalline fraction (at high temperature) with the crystallization cycle are measured (wt.-% SF, wt.-% C₂, iV).

### c) Xylene Cold Solubles (XCS)

The xylene cold solubles (XCS, wt.-%) were determined at 25° C. according to ISO 16152; first edition; 2005-07-01.

### d) Intrinsic Viscosity

Intrinsic viscosity was measured according to DIN ISO 1628/1, October 1999 (in Decalin at 135° C.).

### e) Quantification of Microstructure by NMR Spectroscopy—Ethylene Content in HECO

Quantitative nuclear-magnetic resonance (NMR) spectroscopy was used to quantify the comonomer content of the polymers. Quantitative ¹³C{¹H}NMR spectra were recorded in the solution-state using a Bruker Advance 111 400 NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 65 mM solution of relaxation agent in solvent (Singh, G., Kothari, A., Gupta, V., Polymer Testing 28 5 (2009), 475). To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 1128). A total of 6144 (6k) transients were acquired per spectra. Quantitative ¹³C{¹H}NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed Cheng, H. N., Macromolecules 17 (1984), 1950).

With characteristic signals corresponding to 2,1 erythro regio defects observed (as described in L. Resconi, L. Cavallo, A. Fait, F. Piemontesi, Chem. Rev. 2000, 100 (4), 1253, in Cheng, H. N., Macromolecules 1984, 17, 1950, and in W-J. Wang and S. Zhu, Macromolecules 2000, 33 1157) the correction for the influence of the regio defects on determined properties was required.

Characteristic signals corresponding to other types of regio defects were not observed.

The comonomer fraction was quantified using the method of Wang et al. (Wang, W-J., Zhu, S., Macromolecules 33 (2000), 1157) through integration of multiple signals across the whole spectral region in the ¹³C{¹H}spectra. This method was chosen for its robust nature and ability to account for the presence of regio-defects when needed. Integral regions were slightly adjusted to increase applicability across the whole range of encountered comonomer contents.

For systems where only isolated ethylene in PPEPP sequences was observed the method of Wang et al. was modified to reduce the influence of non-zero integrals of sites that are known to not be present. This approach reduced the overestimation of ethylene content for such systems and was achieved by reduction of the number of sites used to determine the absolute ethylene content to:

$$E = 0.5 ( S ββ + S β γ + S βδ + 0.5 ( Sa β + S αγ ) )$$

Through the use of this set of sites the corresponding integral equation becomes:

$$E = 0 \text{.5} ( {I}_{H} + {I}_{G} + 0.5 ( {I}_{C} + {I}_{D} ) )$$

using the same notation used in the article of Wang et. al. (Wang, W-J., Zhu, S., Macromolecules 33 (2000), 1157). Equations used for absolute propylene content were not modified.

The mole percent comonomer incorporation was calculated from the mole fraction:

$$E [ mol - \% ] = 100 * fE$$

The weight percent comonomer incorporation was calculated from the mole fraction:

$$E [ wt \% ] = 100 * ( {fE}^{⋆} 28.06 ) / ( ( fE * 28.06 ) + ( ( 1 - fE ) * 42. 08 ) )$$

The comonomer sequence distribution at the triad level was determined using the analysis method of Kakugo et al. (Kakugo, M., Naito, Y., Mizunuma, K., Miyatake, T. Macromolecules 15 (1982) 1150). This method was chosen for its robust nature and integration regions slightly adjusted to increase applicability to a wider range of comonomer contents.

### f) Flexural Modulus (FM)

The Flexural Modulus (FM) was determined in 3-point-bending according to ISO 178 on injection molded specimens as described in EN ISO 1873-2 with dimensions of 80×10×4 mm³. Crosshead speed was 2 mm/min for determining the flexural modulus.

### g) Charpy Notched Impact Strength (Charpy NIS)

Charpy Notched Impact Strength was determined according to ISO 179-1 eA at +23° C. and at −20° C. on injection molded specimens as described in EN ISO 1873-2 with dimensions of 80×10×4 mm³.

### h) Coefficient of Linear Thermal Expansion (CLTE)

The coefficient of linear thermal expansion (CLTE) was determined in accordance with ISO 11359-2:1999 on 10 mm long pieces cut from the same injection molded specimens as used for the flexural modulus determination. The measurement was performed in a temperature range from −30 to +80° C. at a heating rate of 1° C./min and a temperature range from 23 to +80° C. at a heating rate of 1° C./min in machine direction, respectively.

### i) Paint Adhesion

Adhesion is characterized as the resistance of decorative coatings such as paints when subjected to high-pressure cleaner washing following certain conditions as described below. Injection moulded sample plates (150 mm×80 mm×3 mm) were produced at 240° C. melt temperature and 50° C. mold temperature. The flow front velocity was 100 mm/s. Prior to coating, the plaques were cleaned with Zeller Gmelin Divinol® mm/s for 5 min. Subsequently, the surface was activated via flaming, where a burner at a speed of 670 mm/s spreads a mixture of propane (9 I/min) and air (180 I/min) in a ratio of 1:20 on the polymer substrate. The step of flaming was performed two times. Afterwards, the polymer substrate was coated with 2 layers, a base coat (black, Wörwag R2342) and a clear coat (Wörwag R3203H).

The decorative coating was incised down to the substrate at a total depth of about 130 μm (including coating and substrate) with a Sikkens cutting tool making a cross with 100 mm long branches. On each coated substrate, 3 lines with the corresponding cross were incised. The incised area was further exposed to a stream of hot water with temperature T which was directed for a time t at a distance d under an angle α to the surface of the test panel. Pressure of the water jet results from the water flow rate and is determined by the type of nozzle installed at the end of the water pipe.

The following parameters were used:

T (water)=60° C.; t=60 s; d=100 mm, α=90°, water pressure of 60 bar, nozzle type=Walter 13/32.

The adhesion was assessed by quantifying the failed or delaminated coated area in mm² per test line. For each example, 5 panels (150 mm×80 mm×3 mm) have been tested. For this purpose, an image of the test line before and after steam jet exposure was taken. Then the delaminated area was calculated with an image processing software. The average failed area for 3 test lines on 5 test specimens (i.e. in total the average of 15 test points) was reported as average failed area.

### j) Median Particle Size D50 (Sedimentation)

The median Particle Size D50 (Sedimentation) is calculated from the particle size distribution [mass percent] as determined by gravitational liquid sedimentation according to ISO 13317-3 (Sedigraph).

### k) Particle Size and Particle Size Distribution

The particle size distribution was determined using laser diffraction measurements by Coulter LS 200. The particle size and particle size distribution is a measure for the size of the particles. The D-values (D10 (or d10), D50 (or d50) and D90 (or d90)) represent the intercepts for 10%, 50% and 90% of the cumulative mass of sample. The D-values can be thought of as the diameter of the sphere which divides the sample's mass into a specified percentage when the particles are arranged on an ascending mass basis. For example the D10 is the diameter at which 10% of the sample's mass is comprised of particles with a diameter less than this value. The D50 is the diameter of the particle where 50% of a sample's mass is smaller than and 50% of a sample's mass is larger than this value. The D90 is the diameter at which 90% of the sample's mass is comprised of particles with a diameter less than this value. The D50 value is also called median particle size. From laser diffraction measurements according to ISO 13320 the volumetric D-values are obtained, based on the volume distribution.

### i) Differential Scanning Calorimetry (DSC)

Differential scanning calorimetry (DSC) analysis, melting temperature (Tₘ) and melt enthalpy (Hₘ), crystallization temperature (T_{c}), and heat of crystallization (H_{c}, H_{cr}) are measured with a TA Instrument Q200 differential scanning calorimetry (DSC) on 5 to 7 mg samples. DSC is run according to ISO 11357/part 3/method C₂ in a heat/cool/heat cycle with a scan rate of 10° C./min in the temperature range of −30 to +225° C.

Crystallization temperature (T_{c}) and heat of crystallization (H_{c}) are determined from the cooling step, while melting temperature (Tₘ) and melt enthalpy (Hₘ) are determined from the second heating step.

Throughout the description the term T_{c} or (T_{cr}) is understood as Peak temperature of crystallization as determined by DSC at a cooling rate of 10 K/min (i.e. 0.16 K/sec).

### 2. Examples

### a) Materials

HECO1 is a high flow heterophasic propylene copolymer prepared as described below. Polymerization details are given in Table 1 below, properties are given in Table 2 below.

HECO-A is a high flow heterophasic propylene copolymer having an MFR2 of 100 g/10 min prepared with a Ziegler-Natta catalyst commercially available from Lyondell Basell under the tradename “Avant ZN180M” in combination with triethyl-aluminium (TEAL) as co-catalyst and dicyclopentadienyl-dimethoxy silane (donor D) as external donor. Polymerization details are given in Table 1 below, properties are given in Table 2 below.

HECO2 is an heterophasic propylene copolymer (HECO), having an MFR2 of 11 g/10 min prepared with a Ziegler-Natta catalyst as used for HPP2 in WO 2014191211 A1, the catalyst preparation concept is described in general e.g. in patent publications EP491566, EP591224 and EP586390. The catalyst was used in combination with triethyl-aluminium (TEAL) as co-catalyst and dicyclopentadienyl-dimethoxy silane (donor D) as external donor. Polymerization details are given in Table 1 below, properties are given in Table 2 below.

Propylene homopolymer HJ120UB having an MFR2 (230° C., 2.16 kg) of 75 g/10 min is commercially available from Borealis AG, Austria.

PP-H is a propylene homopolymer having an MFR2 (230° C., 2.16 kg) of 75 g/10 min, prepared in a single loop reactor using the same metallocene catalyst as for HECO1.

Ethylene-octene elastomer Engage 8100 having a density 870 kg/m³ and a MFR2 (190° C.; 21.16 kg) of 1 g/10 min is commercially available from Dow Chemical, USA.

Ethylene-octene copolymer Engage 8137 having a density of 864 kg/m³ and a MFR2 (190° C.; 21.16 kg) of 13 g/10 min f is commercially available from Dow Chemical, USA.

Talc Luzenac HAR T84 having an average particle size D50 of 11.5 μm is used as inorganic filler, commercially available from Imerys Talc, France.

HC001A-B1 is a polypropylene homopolymer having a MFR2 (230° C., 2.16 kg) of 2.7 g/10 min and a density of 905 kg/m³, and is commercially available from Borealis AG, Austria.

Additive 1 is a Carbon black masterbatch based on polyethylene commercially available as CBMB-LD.09 from Premix Oy, Finland.

Additive 2 is an antistatic agent being a glycerol ester, commercially available as Dimodan HP (CAS-no. 97593-29-8) from Danisco GmbH, Austria.

Additive 3 is a phosphorous based antioxidant, commercially available as Irgafos 168 (FF) (CAS-no. 31570-04-4) from BASF AG, Germany.

Additive 4 is calcium stearate as acid scavenger, commercially available as Ceasit SW (CAS-no. 1592-23-0) from Baerlocher, Germany.

Additive 5 is a sterically hindered phenol as antioxidant, commercially available as Irganox 1010 (FF) (CAS-no. 6683-19-8) from BASF AG, Germany.

### b) Polymerization of HEC01

The following catalyst was used for preparing HECO1. A metallocene complex has been used as described in WO 2019/179959 A1:

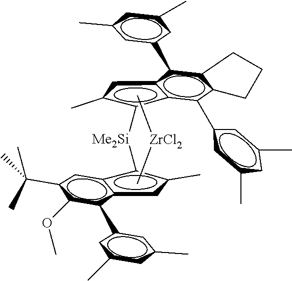

[rac-anti-dimethylsilanediyl[2-methyl-4,8-bis-(3′,5′-dimethylphenyl)-1,5,6,7-tetrahydro-s-indacen-1-yl][2-methyl-4-(3′,5′-dimethylphenyl)-5-methoxy-6-tert-butylinden-1-yl]zirconium dichloride]

The supported metallocene catalyst was produced analogously to IE2 in WO 2019/179959 A1.

HECO1 was prepared with said catalyst in a Borstar PP pilot unit with sequential process comprising a pre-polymerization reactor, a loop reactor and two gas phase reactors. Polymerization and reactor conditions are given in Table 1 below.

TABLE 1
Preparation of the heterophasic propylene
copolymers HECO1, HECO-A and HECO2

| | | |
|---|---|---|
| HECO1 | HECO-A | HECO2 |

Prepolymerisation reactor

| | | | | |
|---|---|---|---|---|
| Co/ED | mol/mol | — | 10 | 7.3 |
| Co/Ti | mol/mol | — | 220 | 220 |
| Temperature | ° C. | 20 | 30 | 30 |
| Pressure | kPa | 5283 | 5350 | 5350 |
| Catalyst feed | kg/h | 2.33 | 1.10 | 1.10 |
| TEAL feed | g/tC3 | 3.00 | 12 | 12 |
| H2/C3 ratio | mol/kmol | 0.05 | 0.10 | 0.10 |
| Residence time | h | 0.34 | 0.09 | 0.09 |
| Loop reactor | | | | |
| Temperature | ° C. | 70 | 75 | 75 |
| Pressure | kPa | 5367 | 5320 | 5320 |
| H2/C3 ratio | mol/kmol | 0.32 | 22 | 14.8 |
| Polymer Split | wt.-% | 51 | 52 | 30 |
| Polymer residence time | h | 0.39 | 0.40 | 0.35 |
| MFR2 | g/10 min | 58.4 | 160 | 55 |
| Gas phase reactor 1 | | | | |
| Temperature | ° C. | 75.0 | 80 | 80 |
| Pressure | kPa | 2500 | 2550 | 2550 |
| H2/C3 ratio | mol/kmol | 5.55 | 175 | 149.7 |
| Polymer Split | wt.-% | 37 | 34 | 35 |
| Polymer residence time | h | 1.80 | 1.60 | 1.60 |
| MFR2 | g/10 min | 164 | 160 | 55 |
| MFR2 in GPR1 (calc.) | g/10 min | 850 | 160 | 55 |
| Gas phase reactor 2 | | | | |
| Temperature | ° C. | 70 | 80 | 70 |
| Pressure | kPa | 2400 | 2450 | 2400 |
| H2/C2 ratio | mol/kmol | 1.90 | 250 | 116.5 |
| C2/C3 ratio | mol/kmol | 859 | 550 | 584.6 |
| Polymer Split | wt.-% | 12 | 14 | 20 |
| Polymer residence time | h | 1.80 | 1.65 | 1.95 |
| Gas phase reactor 3 | | | | |
| Temperature | ° C. | — | — | 85 |
| Pressure | kPa | — | — | 2360 |
| H2/C2 ratio | mol/kmol | — | — | 92.7 |
| C2/C3 ratio | mol/kmol | — | — | 585.2 |
| Polymer Split | wt.-% | — | — | 15 |
| Polymer residence time | h | — | — | 1.80 |
| XCS total | wt.-% | 11.9 | 15.0 | 32.9 |
| C2 total | wt.-% | 2.7 | 8.8 | 15.1 |
| C2(XCS) | wt.-% | 23.4 | 44.0 | 34.4 |
| IV(XCS) | dl/g | 2.5 | 2.0 | 3.6 |

Properties of the heterophasic propylene copolymers HECO1, HECO-A and HEC02 are given in Table 2 below.

TABLE 2
Properties of the heterophasic propylene copolymers

| | | HECO1 | HECO-A | HECO2 |
|---|---|---|---|---|
| Pellet data | | | | |
| MFR2 | g/10 min | 91 | 100 | 11 |
| Tm | ° C. | 152 | 165 | 165 |
| Tc | ° C. | 118 | 121 | 116 |
| Crystex data | | | | |
| SF | wt.-% | 12.1 | 15 | 31.3 |
| CF | wt.-% | 87.9 | 85 | 68.7 |
| C2 | wt.-% | 3.5 | 8.8 | 15.1 |
| C2(SF) | wt.-% | 22.2 | 39 | 38.6 |
| C2(CF) | wt.-% | 0 | 3.5 | 5.1 |
| IV | dl/g | 1.3 | 1.4 | 2.1 |
| IV(SF) | dl/g | 2.7 | 2.9 | 3.6 |
| IV(CF) | dl/g | 1.1 | 1.1 | 1.5 |
| IV(SF)/IV(CF) | — | 2.45 | 2.64 | 2.39 |

The compositions were prepared by melt blending using a twin-screw extruder Coperion ZSK-40. During the compounding the following temperature profile was set: 190, 210, 230, 210° C.

The components and the amounts applied in the preparation of inventive polypropylene composition IE1 and comparative polypropylene compositions CE1, CE2 and CE3 are summarized in Table 3 below.

TABLE 3
Inventive and comparative compositions

| Components, wt.-% | IE1 | CE1 | CE2 | CE3 |
|---|---|---|---|---|
| HECO1 | 38.16 | | | |
| HECO-A | | 38.2 | | |
| HECO2 | 22.44 | 22.4 | 42.5 | 42.5 |
| PP-H | | | 19.0 | |
| Propylene homopolymer (HJ120UB) | | | | 19.0 |
| Ethylene copolymer (Engage 8100) | 13.90 | 13.9 | | |
| Ethylene copolymer (Engage 8137) | | | 13.0 | 13.0 |
| Filler (Luzenac HAR T84) | 22.00 | 22.0 | 22.0 | 22.0 |
| HC001A-B1 | 1.33 | 1.43 | 1.36 | 1.38 |
| Additive 1 | 1.50 | 1.50 | 1.50 | 1.50 |
| Additive 2 | 0.29 | 0.29 | 0.29 | 0.29 |
| Additive 3 | 0.14 | 0.11 | 0.12 | 0.11 |
| Additive 4 | 0.12 | 0.10 | 0.13 | 0.13 |
| Additive 5 | 0.12 | 0.07 | 0.10 | 0.09 |

Properties of inventive polypropylene composition IE1 and comparative polypropylene compositions CE1, CE2 and CE3 are summarized in Table 4 below.

TABLE 4
Properties of the inventive and comparative compositions

| | | IE1 | CE1 | CE2 | CE3 |
|---|---|---|---|---|---|
| MFR2 (230° C.; 2.16 | g/10 min | 20.0 | 20.2 | 17.6 | 16.5 |
| kg) | | | | | |
| Flexural modulus | MPa | 2174 | 2272 | 1997 | 2056 |
| Charpy NIS +23° C. | kJ/m² | 42.9 | 41.6 | 43.5 | 41.0 |
| Charpy NIS −20° C. | kJ/m² | 6.3 | 6.1 | 7.0 | 6.6 |
| CLTE +23/80° C. | μm/m/° C. | 65.2 | 56.3 | 62.3 | 57.9 |
| CLTE −30/80° C. | μm/m/° C. | 51.4 | 44.4 | 50.2 | 46.7 |
| Delamination area | mm² | 52 | 59 | 75 | 68 |
| (2 L/Sikkens/130 μm) | | | | | |

As can be seen from the results shown in Table 4, IE1 performs best in the delamination test and shows at the same time high stiffness (flexural modulus), good impact strength and comparable CLTE.

1. Composition for automotive exterior components, the composition comprising
a) 30 to 45 wt.-%, based on the total weight of the composition, of a first heterophasic propylene copolymer (HECO1) having a melt flow rate MFR2 of 70 to 250 g/10 min determined according to ISO 1133 at 230° C. and 2.16 kg load,
a soluble fraction (SF) content of 6 to 22 wt.-% based on the total weight of the first heterophasic propylene copolymer (HECO1) as determined according to the CRYSTEX method, and
an ethylene content C₂(SF) of 15 to 30 wt.-% based on the total weight of the soluble fraction (SF) of the heterophasic propylene copolymer (HECO1) as determined by Fourier transform infrared spectroscopy (FTIR) calibrated with ¹³C-NMR spectroscopy,
b) 15 to 30 wt.-%, based on the total weight of the composition, of a second heterophasic propylene copolymer (HECO2) having an MFR2 of 5 to 15 g/10 min determined according to ISO 1133 at 230° C. and 2.16 kg load,
a soluble fraction (SF) content of 25 to 45 wt.-% based on the second heterophasic propylene copolymer (HECO2) as determined according to the CRYSTEX method, and
an ethylene content C₂(SF) of more than 30 to 50 wt.-% based on the total weight of the soluble fraction (SF) of the heterophasic propylene copolymer (HECO2) as determined by Fourier transform infrared spectroscopy (FTIR) calibrated with ¹³C-NMR spectroscopy,
c) 8 to 18 wt.-%, based on the total weight of the composition, of an ethylene copolymer having a density of 860 to 880 kg/m³ determined according to ISO 1183, and
an MFR2 of 0.1 to 3.0 g/10 min determined according to ISO 1133 at 190° C. and 2.16 kg load,
d) 15 to 30 wt.-%, based on the total weight of the composition, of an inorganic filler, wherein the composition has an MFR2 of 15 to 30 g/10 min determined according to ISO 1133 at 230° C. and 2.16 kg load.

2. Composition according to claim 1, wherein the first heterophasic propylene copolymer (HECO1) has a melting temperature Tₘ in the range of 145 to 160° C. determined by differential scanning calorimetry (DSC) according to ISO 11357, and/or an intrinsic viscosity of the soluble fraction (IV(SF)) of 2.0 to 3.5 dl/g as determined in decalin according to ISO 1628-3.

3. Composition according claim 1,
wherein the second heterophasic propylene copolymer (HECO2) has an intrinsic viscosity of the soluble fraction (IV(SF)) of 3.0 to 7.0 dl/g as determined in decalin according to ISO 1628-3 and/or
a melting temperature Tₘ in the range of 162 to 170° C. determined by differential scanning calorimetry (DSC) according to ISO 11357.

4. Composition according claim 1,
wherein the ethylene copolymer is a copolymer of ethylene and an alpha-olefin having 3 to 10 carbon atoms, preferably 8 carbon atoms.

5. Composition according claim 1, further comprising
e) 0.5 to 5.0 wt.-%, based on the total weight of the composition, of an additive.

6. Composition according to claim 5, wherein the additive comprises one or more antioxidant(s), a UV stabilizer, an antistatic agent, an acid scavenger, a nucleating agent, carbon black or a mixture thereof.

7. Composition according claim 1,
wherein the inorganic filler is selected from talc, wollastonite, kaolin, mica, clay or a mixture thereof, preferably the inorganic filler is talc.

8. Composition according claim 1,
wherein the inorganic filler has a median particle size D50 of 5 to 20 μm.

9. Composition according claim 1, further comprising
f) up to 3 wt.-%, based on the total weight of the composition, of a propylene homopolymer (PP-H).

10. Composition according to claim 9, wherein the propylene homopolymer (PP-H) has an MFR2 of 1 to 100 g/10 min determined accordingto ISO 1133 at 230° C. and 2.16 kg load.

11. Composition according claim 1,
wherein the first heterophasic propylene copolymer (HECO1) comprises a fraction soluble in cold xylene at 25° C. (XCS fraction) in an amount in the range of 6 to 22 wt.-%, based on the total weight of the first heterophasic propylene copolymer (HECO1), and/or wherein the first heterophasic propylene copolymer (HECO1) has a total ethylene content (C₂ total) in the range of 1.8 to 6.5 wt.-% based on the total weight of the first heterophasic propylene copolymer (HECO1) as determined by Fourier transform infrared spectroscopy (FTIR) calibrated with ¹³C-NMR spectroscopy.

12. Composition according claim 1,
wherein the composition has a flexural modulus in the range of 1750 to 2750 MPa determined according to ISO 178 on injection molded specimens.

13. Composition according claim 1,
wherein the composition has a Charpy notched impact strength at 23° C. in the range of more than 30 to 75 kJ/m² determined according to ISO 179/eA on injection molded specimens.

14. Article comprising the composition according to claim 1, the article preferably being an automotive exterior component.

15. A method for improving the adhesion of paint, the method comprising adding to the paint the composition of claim 1.
